(19) United States
(12) Patent Application Publication
(10) Pub. No.: US 2026/0292375 A1
(43) Pub. Date: Sep. 24, 2026

(54) Optical Switch with Fast Switching and Fast Transceiver Acquisition

(71) Applicant: Ciena Corporation, Hanover, MD (US)

(72) Inventors: Daniel Rivaud, Ottawa (CA); David W. Boertjes, Nepean (CA); Spencer Giacalone, Ottawa (CA); James Tierney, Ottawa (CA); James Harley, Nepean (CA)

(73) Assignee: Ciena Corporation, Hanover, MD (US)

(21) Appl. No.: 19/082,887

(22) Filed: Mar. 18, 2025

(51) Int. Cl. H04Q 11/00

(52) U.S. Cl. CPC H04Q 11/0066; H04Q 11/0005; H04Q 2011/0007; H04Q 2011/0064

(57) ABSTRACT

This disclosure presents systems and methods for an optical circuit switch (OCS), optical burst switch (OBS), and hybrid OBS (HOBS) featuring microsecond-range reconfiguration times—critical for modern AI/ML workloads demanding both low latency and high bandwidth. By combining fast switching elements (e.g., silicon photonics) with burst-mode transceivers that reduce acquisition from seconds to microseconds, the proposed architectures enable efficient data center interconnects. The design coordinates switch reconfiguration and transceiver lock-in through in-band or out-of-band control, minimizing overhead to under ten percent of each burst's duration. Additional optimizations—such as buffering packet headers, using a second wavelength for control signals, and employing partial DSP training—further boost performance while reducing power consumption. These fast optical switches support both short, frequent bursts (scale-up) and large, stable flows (scale-out), delivering high-throughput, low-latency connections suitable for AI/ML clusters, HPC environments, and other dynamic data center applications.

### FIELD OF THE DISCLOSURE

The present disclosure relates generally to networking and computing. More particularly, the present disclosure relates to systems and methods for an optical circuit switch (OCS), an optical burst switch (OBS), and a hybrid OBS (HOBS) with fast switching and with fast transceiver acquisition.

### BACKGROUND OF THE DISCLOSURE

An optical circuit switch (OCS) provides transparent, high-capacity connectivity between multiple input ports to multiple output ports without requiring optical-to-electrical conversion. Such OCS architectures are attractive for data centers and high-performance computing due to their reduced latency and increased bandwidth (i.e., relative to electrical switches and routers). Optical burst switching (OBS) builds on this concept by setting up an optical path only for the duration of a “burst” (i.e., a flow of data sent as a contiguous unit), whereas circuits in an OCS are typically maintained for significantly greater time. Under OBS, a control plane (often out-of-band) alerts the switch before each burst arrives, allowing data to transmit at full line rate once the switch configures the path. Hybrid optical burst switching (HOBS), in turn, refines OBS by introducing in-band signaling or headers to detect burst information directly on the optical signal. This enables more dynamic reconfiguration, as the system can decode control information within the data stream itself, rather than relying exclusively on external commands.

### BRIEF SUMMARY OF THE DISCLOSURE

Traditional OCS, OBS, and HOBS solutions face significant challenges when confronted with rapidly changing flows—such as those in artificial intelligence (AI) and machine learning (ML) clusters—that require high bandwidth and low latency. Most OCS technologies rely on mechanical or thermal switching elements that take milliseconds to reconfigure, and even advanced hardware must contend with physical layer training and higher-level coordination overhead, further pushing switching times into the millisecond range. Additionally, conventional coherent optical transponders may need five to ten seconds to lock onto a new signal, rendering them unsuitable for short-lived bursts in OBS or HOBS deployments—where optical paths must reconfigure on a microsecond timescale to support rapid, high-bandwidth traffic in data centers. To overcome these limitations, the present disclosure provides systems and methods for optical burst switching and hybrid optical burst switching featuring fast switching and fast transceiver acquisition, along with sophisticated control mechanisms. By coordinating switch reconfiguration with quick transceiver lock-in, these solutions markedly reduce overall setup times, enabling burst or flow-based optical communications to excel in AI/ML, high-performance computing, and large-scale data center environments, while improving throughput, reducing latency, and enhancing resource utilization over conventional approaches.

In an embodiment, a system for fast optical switching includes an optical switch having N ports, wherein the optical switch is configured to reconfigure optical paths among the N ports in a microsecond or sub-microsecond timescale; a plurality of burst-mode optical transceivers coupled to respective ones of the N ports, each burst-mode optical transceiver configured to establish optical communication with another burst-mode optical transceiver via the optical switch, and to acquire an optical signal in a microsecond or sub-microsecond timescale upon reconfiguration of the optical switch; and a control system configured to coordinate switching events in the optical switch with acquisition events in the burst-mode optical transceivers. The control system and the burst-mode optical transceivers can operate together to enable short-lived, high-bandwidth connections suitable for optical burst switching (OBS) or hybrid optical burst switching (HOBS).

The optical switch can be implemented via silicon photonics (SiP) technology, including one or more of Mach-Zehnder interferometers, ring resonators, or free-carrier injection elements, each reconfigurable to achieve the microsecond or sub-microsecond timescale. At least one burst-mode optical transceiver can be a coherent light transceiver optimized for short-reach data center or campus environments, configured to reduce digital signal processing (DSP) complexity and perform partial or incremental training to achieve faster acquisition. At least one burst-mode optical transceiver can be an intensity-modulation direct-detect (IMDD) transceivers, and wherein the control system pre-coordinates optical path changes to allow the IMDD transceivers to re-lock within microseconds. At least one burst-mode optical transceiver can include an always-on host SerDes interface and a burst-mode line side, such that the host SerDes remains continuously active while only the line side retrains upon each new optical path established through the optical switch.

The control system can be realized over an out-of-band (OOB) interface, the control system sending reconfiguration commands to the optical switch ahead of a flow change, enabling each burst-mode optical transceiver to anticipate and minimize reacquisition time. The control system can be realized through an in-band control plane, each burst-mode optical transceiver including a small optical tap or in-band header-detection logic for identifying burst or flow setup data and signaling the optical switch to reconfigure accordingly. At least one burst-mode optical transceiver can further include a buffer configured to aggregate multiple packet headers into a single flow-level header at a start of a burst, thereby reducing redundant header overhead and minimizing repeated acquisition steps during a burst. At least one burst-mode optical transceiver can be configured to run an asymmetric line rate, buffering host-side traffic at a first rate and transmitting to the optical switch at a higher rate in order to mask reconfiguration or DSP lock times. At least one burst-mode optical transceiver can include dual-wavelength capability, employing a primary data wavelength and a secondary control wavelength, the secondary control wavelength configured to convey switch reconfiguration commands without interrupting data flow.

The system can further include a wake-up signaling mechanism wherein a host device or graphics processing unit (GPU) transmits an out-of-band wake-up code via one of the burst-mode optical transceivers to a remote transceiver, causing the remote transceiver to pre-initialize clock and carrier recovery before data arrives. The control system can support multi-stage path setup, allowing an end-to-end connection to be formed from multiple intermediate segments in parallel or in series, reducing overall reconfiguration latency through overlapping or incremental acquisition. At least one burst-mode optical transceiver can be integrated as co-packaged optical (CPO) or on-board optical (OBO), placing its optical and DSP components in close proximity to a host application-specific integrated circuit (ASIC) for shorter electrical interfaces and faster acquisition.

In another embodiment, a method for fast optical switching includes steps of configuring an optical switch having N ports to reconfigure optical paths among the N ports in a microsecond or sub-microsecond timescale; coupling a plurality of burst-mode optical transceivers to respective ones of the N ports, each burst-mode optical transceiver being operable to establish optical communication with another burst-mode optical transceiver via the optical switch and to acquire an optical signal in a microsecond or sub-microsecond timescale when the optical switch reconfigures; and coordinating switching events in the optical switch with acquisition events in the burst-mode optical transceivers via a control system, thereby minimizing overall reconfiguration and transceiver lock time. The steps can further include operating the control system and the burst-mode optical transceivers together to enable short-lived, high-bandwidth connections suitable for optical burst switching (OBS) or hybrid optical burst switching (HOBS).

The steps can further include implementing the optical switch in silicon photonics (SiP) technology using phase-shifting elements or ring resonators, and executing reconfiguration instructions to achieve the microsecond or sub-microsecond timescale. The steps can further include retaining certain digital signal processing (DSP) parameters in each burst-mode optical transceiver so that, upon a new connection setup, the transceiver only performs partial re-lock procedures, thereby reducing acquisition from seconds to microseconds. The steps can further include maintaining a host-side serializer-deserializer (SerDes) interface continuously active while activating a burst-mode line side only after receiving notification of an impending optical path change; and instructing the burst-mode optical transceivers to switch to a new optical path in coordination with the control system so that any overhead for re-locking remains below ten percent of each data flow's duration. The steps can further include employing a second wavelength in each optical link for control signals, enabling the optical switch to be reconfigured without interrupting main data flow on a primary wavelength.

### BRIEF DESCRIPTION OF THE DRAWINGS

The present disclosure is illustrated and described with reference to the various drawings. Like reference numbers are used to denote like components/steps, as appropriate. Unless otherwise noted, components depicted in the drawings are not necessarily drawn to scale.

FIGS. 1 and 2 illustrate an OBS configuration and a HOBS configuration using a fast optical switch and burst plugs for describing the system architecture.

FIGS. 3 and 4 illustrates the OBS configuration and the HOBS configuration with associated NCCL commands.

FIG. 5 illustrates a flowchart of a process for fast optical switching based on the approaches described herein.

### DETAILED DESCRIPTION OF THE DISCLOSURE

The present disclosure provides mechanisms for end-to-end high-speed reconfiguration by coordinating three elements—(1) an optical switch, (2) burst-mode transceivers, and (3) control/signaling—to achieve highly efficient data center interconnects (DCIs), especially in AI and high-performance computing (HPC) workloads. Although the disclosure focuses primarily on optical burst switching (OBS) and hybrid optical burst switching (HOBS), the underlying principles apply equally to optical circuit switching (OCS). Example applications include AI/ML scale-up, wherein a small number of graphics processing units (GPUs) are connected so tightly that they appear as a single GPU, and scale-out, wherein large GPU clusters interconnect in a more conventional data center style. While GPUs are used here for illustration, the same techniques apply to any servers or network elements.

Existing optical switches and transceivers face three main challenges: (1) switching times, (2) optical loss, and (3) connectivity management. Conventional coherent transceivers can require on the order of 10 seconds to reacquire signals after the optical switch reconfigures a link, owing to the overhead in serializer-deserializer (SerDes) electronics and digital signal processors (DSPs). As such, even optical burst switching only proves worthwhile for connections lasting on the order of minutes or longer. In typical networking practice, setup overhead should be roughly 10% or less of the overall connection time, so a 10-second overhead is acceptable only if flows persist for several minutes. This constraint limits the use of coherent transceivers with long acquisition times in OBS and HOBS environments, where desired connection durations can be in the millisecond range.

To enable faster reconfiguration, optical switch designers increasingly turn to silicon photonics (SiP) instead of micro-electromechanical systems (MEMS) mirrors. SiP switches—whether based on Mach-Zehnder interferometers, ring resonators, or free-carrier injection—can reconfigure in times ranging from microseconds to nanoseconds, making them suitable for dynamic, burst-oriented switching in data centers or HPC clusters. In contrast, MEMS mirror-based solutions often take milliseconds or more to physically move the mirrors, favoring static use cases where speed is less critical. While MEMS generally provides lower optical loss at higher port counts (i.e., larger radices), SiP commonly incurs additional insertion loss from waveguide propagation and coupling inefficiencies.

### Use Cases and Considerations for Optical Switching and Transceiver Acquisition

Optical circuit switches (OCS) often introduce 3-6 dB of loss per switching stage, which can be mitigated through either coherent or long-reach (LR) optics. For example, 800LR modules add roughly 3 dB of overhead compared to intensity-modulation direct-detect (IMDD) optics and may require amplification. Some OCS designs include semiconductor optical amplifiers (SOAs) within the switch itself, enabling shorter-reach optics by offsetting inherent losses. Meanwhile, asynchronous physical layers (PHYs) offering ±50 ppm tolerance can synchronize with protocols like Ethernet Precision Time Protocol (PTP) or other clock-handling methods (e.g., ePPS, holdover, or IMP logic) to minimize lock times (sometimes called fast LOAM). Such synchronization helps ensure rapid link re-establishment and minimal timing overhead.

Front-End Super-Spine (Slow OCS, Minutes Timescale). In super-spine applications, an OCS patch panel may require minutes between reconfigurations. For instance, a typical SerDes takes up to 10 seconds to retrain before a newly formed link becomes active, so individual flows must last for several minutes to amortize that overhead. Because super-spine traffic often comprises large, aggregate flows persisting for weeks or months, burst-mode acquisition is generally unnecessary. An octal small form-factor pluggable (OSFP) transceiver is well suited here, where link stability outweighs the need for rapid reconvergence.

Backend Scale-Out (Fast OCS, Tens of Milliseconds Timescale). Scale-out networks frequently manage data-parallel workloads with large messages (e.g., 40 GB) and moderate link speeds (e.g., 800 Gb/s), resulting in transfer times of hundreds of milliseconds. A reconfiguration delay under 40 ms—approximately 10% of message duration—can maintain efficiency. Although data-parallel traffic can be predictable, evolving AI/ML patterns (e.g., model parallelism or tree-based collectives) increase the degree of communication and may benefit from faster switching. An OSFP form factor is again appropriate, with tens-of-milliseconds reconvergence improving resource utilization.

Backend Scale-Up (Fast OBS, Sub-Microsecond Timescale). In scale-up environments, model-parallel traffic often involves smaller messages (e.g., 1 MB) but extremely high speeds (e.g., 8 Tb/s), leading to transfer times on the order of 1 μs per message. To maintain efficiency, acquisition must be under 100 ns—about 10% of the total transfer time. This scenario is ideal for optical burst switching or hybrid OBS, which capitalize on sub-microsecond switching to handle short, frequent bursts. An OSFP or next-generation Optical Internetworking Forum (OIF) Compute Optics Interface (COI) pluggable can satisfy these stringent demands.

Front-End Servers and ToRs (Burst-Mode IMDD+Electronic Packet Switches (EPS), Sub-Microsecond Timescale). At the network edge, where servers or top-of-rack (ToR) switches reside, IMDD pluggables may incorporate burst-mode operation to save power. Traffic here is more bursty than the steady GPU back-end flows, so burst-mode acquisition helps reduce power consumption without sacrificing diagnostic capabilities (e.g., retimed pluggables for debugging). Nonetheless, some buffering is needed to absorb burst startup, thus an acquisition time under 100 ns can keep delays minimal. This near-instant synchronization accommodates frequent switching while preserving overall network efficiency.

### Fast Switching and Acquisition System Architecture

In response to the challenges outlined above, the present disclosure integrates the optical transceivers and optical switch in a single, cohesive system architecture, which includes:
(1) An optical switch employing fast-reconfiguration techniques (e.g., SiP-based designs).
(2) Burst-mode optical transceivers for rapid signal acquisition—either coherent or IMDD-based—using methods to cut acquisition from the conventional 5-10 seconds down to milliseconds or microseconds. These transceivers can be implemented in pluggable modules referred to as “burst plugs.”
(3) Control and flow management to orchestrate when and where the optical switch is reconfigured, ensuring bursts (large data flows) are routed efficiently to their intended destinations.

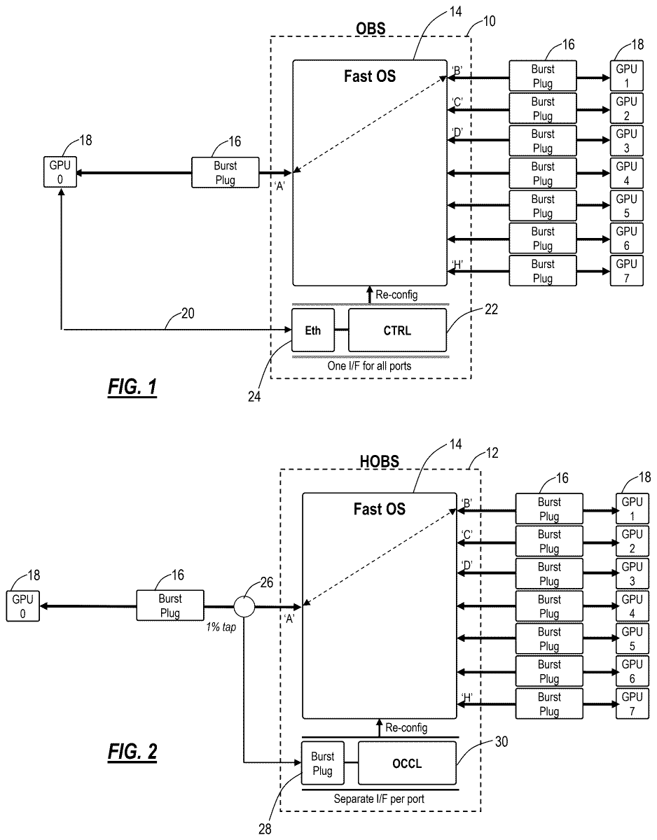

FIGS. 1 and 2 illustrate an OBS configuration 10 and a HOBS configuration 12 using a fast optical switch 14 and burst plugs 16 for describing the system architecture. Again, FIGS. 1 and 2 focus on an AI/ML use case with the OBS configuration 10 and the HOBS configuration 12 configured to switch GPUs 18 (labeled GPU 0, 1, 2, . . . ) between one another for short-lived point-to-point connections, i.e., bursts. In both the OBS configuration 10 and the HOBS configuration 12, the GPUs 18 each connect to a burst plug 16, e.g., each burst plug 16 can be housed in a module supporting each GPU 18 and there can be multiple GPUs 18 and burst plugs 16 in the same module. In an embodiment, the burst plugs 18 can be OSFP modules which can support 800 G bps, 1.6 Tbps, etc.

The difference between the OBS configuration 10 and the HOBS configuration 12 lies in how the optical switch 14 is controlled. In the OBS configuration 10, an out-of-band interface—such as an Ethernet connection 20—links each GPU 18 to a controller 22, which is responsible for reconfiguring the optical switch 14. For instance, Ethernet ports 24 on the controller 22 can each connect to a separate GPU 18 (with FIG. 1 illustrating only an example connection 20 for GPU 0). By contrast, in the HOBS configuration 12, the control interface is in-band: a power tap 26 feeds the optical signal from each burst plug 16 to a receiver 28 (or another burst plug) connected to a control plane referred to as an OCCL 30 (Optical Cross-Connect (OCS) optimized Collective Communications Library (CCL)).

Conceptually, the OBS out-of-band interface is used to notify the external controller 22 before transmitting a burst, allowing coherent or other transceivers to send data once the switch is set. OBS is relatively simple but requires explicit external integration. HOBS, on the other hand, embeds a small receiver 28 in-band, detecting headers directly from the incoming burst to trigger reconfiguration—much like a packet switch. This in-band approach can serve as a drop-in replacement for electronic packet switching but demands more complex “header-detect” logic in the optical domain. An additional benefit of in-band control is that it can reduce costs (by avoiding extra taps or receivers on each OCS port), while out-of-band control supports greater protocol independence and switching speed.

### Fast Optical Switch

The optical switch 14 is an N×N optical circuit switch, where N is an integer, with ports labeled A, B, C, etc., as shown in FIGS. 1 and 2. Each port can function as an input or output, and the switch 14 selectively interconnects these ports to form different optical paths. In one embodiment, the switch is implemented via silicon photonics (SiP) technology, which uses integrated waveguides, phase shifters, and passive optical components fabricated on a silicon substrate. For example, Mach-Zehnder interferometers (MZIs) can serve as the fundamental switching elements: each MZI branch includes a thermo-optic or electro-optic phase shifter that adjusts the optical path length, causing constructive or destructive interference to direct the signal to a desired output port. Another SiP approach employs ring resonators, where injecting or removing charge carriers modulates the ring's refractive index and thus steers optical signals between waveguide paths.

These SiP techniques enable microsecond- to nanosecond-scale reconfiguration times—much faster than mechanical or MEMS mirror-based technologies, which often require milliseconds to physically move mirrors. Although SiP solutions may exhibit higher optical insertion loss than MEMS switches at large radices (i.e., large N), the advantage of rapid, software-controlled switching more than compensates for such losses in applications that demand frequent reconfiguration, such as AI/ML workloads. By integrating waveguides and control electronics on the same silicon die, SiP-based N×N switches offer a compact form factor and fine-grained control over individual switching elements, allowing for low-latency optical connectivity among multiple data paths and making them particularly well suited for burst or flow-oriented switching architectures.

### Burst-Mode Transceivers and Coordination With the Fast Optical Switch

Often times, system designers focus solely on the switching times in the optical switch 14, but practical system deployments are limited by the acquisition time of optical transceivers, i.e., the burst plugs 16. Thus, while nanosecond or microsecond switch times are achievable in the optical system 14, a practical system is limited by the acquisition time of optical transceivers. As such, the present disclosure provides various techniques to reduce the acquisition time from the several seconds described herein. These techniques are embodied in the burst-mode optical transceiver or burst plug 16 with the terms “burst” and “burst-mode” indicating configuration for fast burst switching, in combination with the optical switch 14 and the control plane, in the single system architecture. That is, by incorporated features in the burst plug 16 and coordinating switching events between the optical switch 14 and the burst plugs 16, it is possible to significantly reduce the acquisition time of the burst plugs 16, to the millisecond or microsecond range. Again, for illustration purposes, the burst plug 16 is described as an OSFP, but other approaches are contemplated.

The following items list example techniques used to decrease the burst-mode optical transceiver acquisition time. The present disclosure contemplates the use of any of these as well as in any combination. With respect to modulation formats, the burst-mode optical transceiver can either use (i) a “light” coherent implementation that extend the benefits of coherent optical technology—traditionally used for long-haul and metro/regional networks—into shorter-distance data center and campus environment or (ii) an IMDD implementation such as pulse amplitude modulation (PAM) at varying levels, such as PAM4.
(1) Always-On Host SerDes Configured for Fast Acquisition. One approach is to maintain the host-side SerDes (e.g., on a GPU 18 or an electronic packet switch (EPS)) in an always-on state, while employing burst-mode technology solely on the line side. For instance, an OSFP module can keep its host-side SerDes powered and continuously transmitting idle signals, ensuring there is no need for the GPU or EPS chipsets to support burst-mode behavior. Instead, only the line side—whether implemented as coherent light or IMDD PAM4—undergoes rapid acquisition and lock whenever a new connection is established via the optical switch 14. This arrangement allows existing, non-burst-mode chipsets to remain compatible, significantly lowering the adoption barrier for optical burst switching architectures. In addition, keeping the host SerDes active at all times avoids lengthy retraining intervals on the host side, since the physical-layer negotiation and locking routines occur exclusively in the pluggable module's burst-mode circuitry.
(2) Use of Burst-Mode DSPs (coherent light or IMDD PAM4). Another approach leverages specialized “burst-mode” DSP designs that allow rapid signal reacquisition and lock-in, working in tandem with a fast optical switch 14 and an out-of-band control plane. For instance, the NVIDIA Collective Communications Library (NCCL)—or a similar external orchestration layer—can coordinate switching events ahead of time, signaling when a new optical path will be established. By anticipating the flow change, the burst-mode DSP powers up and initializes only the line side while preserving state information from the previous connection, thereby dramatically reducing lock times from seconds to microseconds or milliseconds. In practice, coherent light or IMDD PAM4 burst-mode transceivers accomplish this by:
(a) Partial or Incremental Training: Rather than fully retraining for each new connection, the DSP retains certain parameters (e.g., filter coefficients) from earlier acquisitions, allowing near-instant convergence.
(b) Fast Clock and Carrier Recovery: A high-speed phase-locked loop (PLL) and minimal overhead synchronization sequences enable quick alignment with the incoming optical signal.
(c) Out-of-Band Coordination: Since the control layer knows exactly when (and where) the optical switch 14 will redirect the flow, the DSP can enter a standby mode, ready to lock within microseconds once the path becomes active.
(3) In-Band Control Plane—HOBS. An alternative to out-of-band control is to embed the control signaling within the optical data itself. In this scenario, a small optical tap (e.g., ~1% of the total signal) is taken from each link and routed to a burst plug 16 capable of performing local header inspection or minimal packet parsing in real time. By detecting flow identifiers or other control bits in-band, the burst plug 16 can make immediate decisions regarding where and how the optical burst should be switched. This reduces latency, because reconfiguration commands do not have to travel through an external controller or out-of-band management channel. In more detail, the optical tap 26 splits off a tiny fraction of the incoming power, passing the majority of the signal onward while sending the tapped portion to a dedicated in-band receiver 28. That receiver then analyzes the incoming headers or control fields—such as destination addresses, flow IDs, or burst setup information—and signals the optical switch 14 to reconfigure accordingly. Because this logic resides physically close to the data path, sub-microsecond reconfiguration is possible, as the switching instructions can be issued almost as soon as the burst header arrives. Further, local (or “pre”) processing within the burst plug 16 reduces overhead on the main data flow: rather than requiring each packet to undergo expensive off-path analysis, only the small tapped signal is parsed for control.
(4) Buffering to Aggregate Packet Headers into a Single Flow Header. A further enhancement uses buffering within the burst plug 16 to consolidate multiple packet headers into a single flow-level header at the beginning of each burst. In this architecture, incoming packets first enter a high-speed buffer or memory queue, where the burst plug strips away individual Ethernet or IP headers. Next, it constructs a reduced-overhead header that encapsulates the collective metadata—such as source, destination, quality-of-service details, or flow-specific parameters—needed for the entire burst. This flow header then precedes the payload data across the optical link. From a fast acquisition perspective, this approach has two major benefits:
(a) Reduced Header Overhead—Since each burst now includes just one comprehensive header rather than multiple packet headers, there is significantly less per-packet overhead. By transmitting fewer repetitive control fields, the transceiver can devote more time and bandwidth to payload data, improving overall throughput.
(b) Minimized Switch and Transceiver Re-Lock Times—In burst-mode or HOBS systems, every new burst can require the optical switch or the remote transceiver to re-lock or reconfigure. By grouping all overhead into a single flow header, the switch and receiver only parse control information once per burst, rather than for each packet. This eliminates repetitive synchronization or processing delays throughout the mid-burst phase.

Additionally, buffering in the burst plug 16 can stabilize incoming traffic patterns, smoothing out short-term bursts and making the flow of data more predictable for the optical switch 14.
(5) Asymmetric Line Rates to Mask Setup Time. An effective strategy to mitigate reconfiguration overhead is to run the line side of the transceiver at a higher data rate than the host side—often referred to as asymmetric line rates. In this design, the burst plug 16 temporarily buffers incoming traffic from the host interface, then transmits that buffered data at a faster line rate once the optical path is established and the transceiver's DSP is locked. From the host's perspective, the data flow continues at a steady, lower rate, while on the line side the burst plug can “catch up” or “compensate” for any downtime incurred during switch reconfiguration or DSP acquisition.

By decoupling the host rate from the line rate:
(a) Seamless Host Experience. The host never sees a significant pause or slowdown, because its SerDes continues sending at the native speed. Meanwhile, the transceiver's internal buffers accumulate data while the optical switch and DSP undergo setup or re-lock intervals.
(b) Faster Line-Side Transmission. Once the optical connection is ready, the burst plug empties its buffers at a speed faster than the host rate. This burst of high-rate transmission effectively masks the lost time from the reconfiguration event, maintaining high overall throughput and minimal end-to-end latency.

Improved Efficiency for Bursty AI/ML Workloads. In AI/ML or HPC environments where large volumes of data must be transferred swiftly, asymmetric line rates ensure that short reconfiguration times—on the order of microseconds or milliseconds—do not unduly restrict effective bandwidth. The faster line side can “make up” any gap caused by transient downtime.

This asymmetric operation is especially beneficial in burst-mode optical switching systems, where frequent reconfigurations would otherwise erode performance. By carefully sizing the buffer and selecting a line rate sufficiently higher than the host interface, operators can maintain near-continuous data flows even in rapidly changing network topologies.
(6) In-Band Detection Coupled with Out-of-Band Control via a Second Wavelength. A further optimization harnesses two separate wavelengths carried over the same physical fiber—one for primary data transmission, the other for out-of-band control signals. In this scheme, the coherent light plug monitors the main (in-band) channel for control information embedded within the traffic itself—such as burst headers or reconfiguration triggers—while also employing a second wavelength to communicate rapid, low-overhead commands to the optical switch 14. A wavelength splitter (or WDM coupler) at each port separates the data wavelength from the control wavelength, allowing them to be processed independently:
(a) Continuous Main Data Flow/Because all control commands travel over the second wavelength, the primary data channel remains uninterrupted. The switch can be updated or reconfigured on the fly without pausing or altering the main data flow, minimizing downtime and latency.
(b) Enhanced Responsiveness. By placing control traffic on a dedicated optical channel, the plug can rapidly issue switching instructions (e.g., which port to connect next) without contending for bandwidth or parsing overhead in the main data stream. This is especially advantageous for AI/ML workloads demanding sub-millisecond or sub-microsecond reconfigurations.
(c) Robust and Flexible Network Design. Running a separate wavelength for out-of-band control mitigates potential crosstalk or signal-to-noise issues that might arise if both data and control signals shared the same modulation. Moreover, system designers can tailor the control wavelength for lower data rates but higher reliability or security, while pushing the primary data wavelength to maximum throughput.
(d) Scalable for Multi-Port Configurations. Each port can include an identical wavelength splitter arrangement, allowing straightforward scaling to large N×N optical switches. As more ports or fibers are added, the second wavelength remains dedicated to coordinating burst arrivals and departures, ensuring consistent performance as the network grows.
(7) Out-of-Band Channel from the Burst Plug with Local Packet Processing. In another approach, the burst plug 16 itself incorporates local intelligence—such as embedded DSP logic, a field programmable gate array (FPGA), or a lightweight processor—to parse incoming packets and extract key control information. Rather than relying on a separate controller or external orchestration to issue reconfiguration commands, the burst plug 16 processes packets (either at an electrical interface or optically) and then uses an out-of-band channel to communicate with the optical switch 14. This arrangement offers several key advantages:
(a) Immediate Decision-Making. By locally inspecting headers or identifying flow identifiers in real time, the burst plug 16 can determine exactly when a traffic flow is starting or ending. As soon as a relevant event is detected, it can trigger the switch to reconfigure without having to consult a remote controller.
(b) Reduced Reaction Time, Because the control signals are sent directly from the plug's out-of-band interface, there is no additional path latency for command relay—especially beneficial in dynamic AI/ML workloads where sub-millisecond or sub-microsecond reconfiguration is desired.
(c) Separation of Data and Control Planes. Routing the control signals over a distinct electrical or optical link ensures the main data flow remains uninterrupted and free of additional overhead. This clean separation can mitigate congestion or scheduling conflicts that might otherwise arise if data and control share the same channel.
(d) Scalable Architecture. Each transceiver (or burst plug) can act as an independent “micro-controller” for its local port. As the network expands to more ports or a larger N×N optical matrix, each burst plug scales the control capability proportionally, avoiding the need for a single, centralized orchestrator to handle all traffic.
(e) Compatibility with Existing Infrastructure. Hosting the intelligence in the plug itself allows the rest of the network—such as GPUs, servers, or electronic packet switches—to operate with their standard SerDes and data interfaces. The plug effectively offloads burst-mode decision-making and timing management from the existing hardware, minimizing the need for upgrades elsewhere in the system.
(8) GPU-Originated Out-of-Band Wake-Up Codes. Another technique for reducing transceiver lock time involves generating wake-up codes directly from the GPU 18 or host device, which are then sent out-of-band via the burst plug 16 to the remote transceiver. By transmitting a special “ready” or “wake-up” signal in advance of an actual data burst, the far-end receiver or DSP can pre-initialize carrier and clock recovery, substantially cutting down on typical retraining intervals. This approach offers multiple advantages:
(a) Rapid Reacquisition. Instead of waiting for the remote device to detect incoming traffic on the primary data channel, the wake-up code proactively signals that a burst is imminent. The far-end DSP or receiver thus has extra time to achieve near-complete frequency, phase, or polarization lock, allowing data transmission to start almost immediately when the burst arrives.
(b) Reduced Idle Latency. In traditional systems, whenever there is no active data, the remote receiver may drop into a low-power or standby mode, requiring seconds of acquisition time upon reactivation. GPU-sourced wake-up codes eliminate these long delays by ensuring the receiver is primed before the burst begins.
(c) Isolation from Main Data Stream. Because the wake-up signal is carried over an out-of-band channel, it does not disrupt the primary data path or add overhead to the main traffic. This clean separation also avoids collisions or confusion with user-level packets.
(d) Minimal Code Overhead. The wake-up sequence itself can be streamlined and short—often just enough bytes to initiate DSP locking routines—further minimizing control overhead. The majority of capacity on the data channel thus remains reserved for payload traffic.
(e) Compatibility with Varying Workloads. This method integrates seamlessly with AI/ML or HPC workloads that have intermittent but high-intensity traffic demands. The GPU simply issues a wake-up code whenever a new data exchange is impending, ensuring the network remains responsive without maintaining full-on synchronization at all times.
(9) Multi-Stage OCS/OBS/HOBS for Partial or “Stitched” Connections.. An additional optimization is to establish end-to-end connectivity through multiple, shorter sub-connections rather than configuring a single, monolithic optical path in one step. In this staged or “stitched” approach, each segment of the route (e.g., from a leaf switch to a spine switch, then from the spine switch to another leaf) is activated independently. As soon as the first link is up, data transmission may begin or buffer locally while subsequent links continue their acquisition process. This strategy mitigates overall reconfiguration overhead by enabling overlapping or parallel lock-in events:
(a) Parallel Acquisition. When the multi-stage path is composed of multiple optical switches, each stage can initiate its own coherent or burst-mode acquisition in parallel. While the initial segments are still in lock-in mode, subsequent segments can start their setup or handoff, minimizing the total end-to-end activation time.
(b) Incremental Traffic Flow. Segmented paths allow data to be partially forwarded or buffered on intermediate nodes, reducing the wait time for the entire connection to be fully established. This incremental approach is especially advantageous in HPC or AI/ML environments where large data sets can be streamed in chunks rather than requiring the entire path to be instantly available.
(c) Fine-Grained Control. Dividing a route into multiple smaller “sub-connections” gives operators the flexibility to re-optimize individual segments based on local network conditions (e.g., congestion, optical loss, or fiber availability). Each segment can use different burst-mode DSP settings or line rates if desired, enhancing robustness and adaptability.
(d) Reduced Setup “Penalty”. By allowing some segments to become “ready” sooner, the overall latency caused by reconfiguration or DSP lock times is masked. Segments that complete acquisition can immediately begin transferring data, while others finish synchronizing. This approach is critical in scenarios demanding very low end-to-end latency yet also requiring frequent path changes.
(e) Scalability for Large-Scale Architectures. Multi-stage stitching is inherently scalable, as additional switch elements can be appended for expanded network reach. Each stage simply negotiates the link with its neighbors, and once established, those segments seamlessly integrate into the larger path.
(10) Non-Pluggable Implementations (On-Board Optical and Co-Packaged Optical). While pluggable transceivers offer modularity and easy upgrade paths, certain applications demand even lower latency and deeper integration. In these cases, On-Board Optical (OBO) or Co-Packaged Optical (CPO) solutions provide a tightly integrated alternative by positioning the optical components—such as lasers, photodiodes, and DSP circuitry—extremely close to the host ASIC on the same board or package. This proximity offers several compelling advantages:
(a) Reduced Signal Degradation. Shortening or eliminating the traditional electrical interface between the host application specific integrated circuit (ASIC) and the optical transceiver significantly lowers signal loss and electromagnetic interference. This results in a cleaner, more stable data path, which in turn enables faster lock times for burst-mode training loops.
(b) Lower Latency. Co-packaged designs minimize the number of electrical interconnects and connectors, reducing both propagation delays and the overhead of transitional circuits (e.g., SerDes). As a result, data can move more directly between the ASIC and optical medium, improving overall latency performance in AI/ML or HPC workloads.
(c) Streamlined Power Usage. When integrating optical components at the board or package level, system designers can optimize power distribution and thermal management more holistically. By consolidating optics with the ASIC, designs can eliminate separate modules, power regulators, or cooling hardware, thus freeing up additional power headroom for faster or more robust DSP operations.
(d) Higher Port Density. OBO or CPO architectures can place multiple optical channels directly on the same substrate as the ASIC, supporting massively parallel throughput with a smaller footprint. This high-density integration is particularly advantageous in large-scale compute clusters that need to accommodate thousands of optical links without sacrificing space or power efficiency.
(e) Improved Burst-Mode Suitability. Because these non-pluggable solutions reduce physical and logical interfaces, the training and retraining loops for burst-mode operation can be executed more quickly. Less complex cabling and fewer handoffs speed up phase or clock alignment, which are crucial for short-duration, high-bandwidth traffic flows.

By applying one or more of these techniques—ranging from redesigned DSPs and intelligent buffering to in-band/out-of-band hybrid control—systems can significantly reduce the transceiver acquisition interval, ultimately enabling high-efficiency, burst-mode optical switching in AI/ML and other dynamic data center environments.

### “Fast” Acquisition Times

Below are illustrative examples of “fast” acquisition times that highlight the differences between traditional and next-generation approaches. While specific numbers vary according to factors like link budget, fiber quality, DSP processing power, and system design constraints, they underscore how recent innovations—from burst-mode DSPs and coherent light optics to PAM4 intensity-based detection—dramatically reduce lock-in intervals:
(1) Traditional Coherent Links (Long-Haul Focus). Long-haul coherent systems often require 5-10 seconds or more for full carrier, clock, and polarization recovery. This high overhead is tolerable for once-infrequent reconfigurations (e.g., setting up a transcontinental link) but unsuitable for data center or AI/ML applications where flows can shift quickly.
(2) Fast Coherent Light. By leveraging reduced DSP complexity, shorter distances, and advanced synchronization techniques (e.g., partial training or asynchronous line rates), coherent-light systems can achieve re-acquisition times of 10-100 μs—a vast improvement over legacy long-haul coherent links. Additional mechanisms like buffering (to aggregate packet headers) or out-of-band wake-up codes can trim these intervals even further. Critically, tight coordination with the optical switch—whether via in-band or out-of-band control—helps ensure that transceivers prepare for the new connection in parallel with switch reconfiguration, minimizing any idle gap. By signaling exactly when and where the optical path is changing, the control plane allows the DSP to enter a ready state before data arrives, accelerating phase lock and clock recovery. This synergy between rapid transceiver acquisition and advance switch instructions enables burst-mode or hybrid optical burst switching architectures to accommodate frequent network reconfigurations while maintaining high throughput.
(3) High-Speed PAM4 Transceivers. Employing simpler intensity-based detection (e.g., PAM4) typically yields 1-10 μs for re-lock in short-range environments, such as top-of-rack or campus interconnects. Because PAM4 avoids the phase/polarization tracking overhead of coherent designs, it can handle fast, frequent flow changes more readily. In addition, coordinating closely with the optical switch and control plane ensures that any reconfiguration commands are sent ahead of time—for example, by using an in-band signaling wavelength or local header inspection within the transceiver. This proactive approach allows the transceiver to pre-initialize its clock-data recovery (CDR) circuitry and other synchronization routines, reducing the period of downtime whenever the path changes. Together, simple DSP processing and timely switch control deliver the ultralow-latency responsiveness essential for dynamic workloads in AI/ML clusters or real-time data center applications.

In practice, advanced solutions like co-packaged optical (CPO) or on-board optical (OBO) can push toward the lower end of these re-lock times by placing transceiver components directly beside the host ASIC, reducing physical interconnect delays. Meanwhile, multi-stage stitching of partial connections can conceal DSP lock intervals through parallel or incremental acquisition. Altogether, compared to legacy coherent systems that demand seconds to synchronize, these next-generation approaches unlock hundreds- to thousands-fold faster reconfigurations, paving the way for burst-mode and flow-based optical switching in dynamic, high-bandwidth environments such as AI/ML, HPC, and modern data centers.

In some scenarios, not all ports on the optical switch 14 carry active traffic at every moment, leaving certain connections IDLE for extended periods. To capitalize on these idle intervals, a burst-mode OSFP transceiver can be configured to enter a burst-OFF state—effectively powering down or placing the line-side optical components and DSP logic into a low-power mode whenever no data is flowing. This significantly reduces average power consumption, addressing the longstanding challenge that coherent solutions traditionally draw higher power than IMDD modules. By allowing a coherent-based burst plug to toggle between high-power (active) and ultra-low-power (idle) states, the overall energy efficiency can approach or even rival that of IMDD plugs. Meanwhile, the coherent transceiver retains its inherent “blast-through” capability—delivering the high optical launch power needed to overcome additional losses introduced by the optical switch 14 (e.g., in silicon photonics or multi-stage architectures). As soon as a new data burst is initiated, the transceiver transitions back to a burst-ON mode, reacquiring the signal quickly through fast lock-in techniques (such as partial DSP training and minimal wake-up codes) so that data flows can resume with minimal delay.

### Scale-UP Vs. Scale-OUT in AI

The following defines the scale-UP and scale-OUT applications in AI.

Scale-UP: A relatively small number (e.g., 8-72) of GPUs that share extremely high-speed interconnects (e.g., NVLink). Low latency and very large bandwidth between these GPUs make them appear as one “giant GPU.” Fast reconfiguration (on the order of microseconds) can be beneficial here.

Scale-OUT: Very large clusters (100,000+ GPUs) connected in a bigger, more conventional data-center style. Flow durations are generally long enough that a slightly slower OCS may still be acceptable (since switching overhead is amortized over large bursts).

### Flow Management

In certain AI/ML workloads, traffic between GPUs is highly connection-oriented, making it an ideal candidate for the OBS configuration 10 or the HOBS configuration 12. Underlying collective communication libraries (CCLs), such as the open-source NVIDIA Collective Communications Library (NCCL), organize even all-to-all or broadcast operations around point-to-point (P2P) exchanges. This approach stems from remote direct memory access (RDMA) requirements, wherein a receiver must allocate memory in advance before a sender can initiate data transfer—an arrangement closely resembling the “call setup/teardown” paradigm in traditional telephony. OBS/HOBS systems are therefore well-suited for such “call-like” traffic patterns because they can dynamically set up short-lived, high-bandwidth optical paths and then tear them down once data has been delivered.

Beyond AI/ML clusters, other connection-oriented or on-demand traffic profiles exhibit similar behaviors. Front-end data center networks, for instance, frequently coordinate short, bandwidth-intensive data flows while maintaining minimal idle overhead. Likewise, regional data centers, television channel hopping, real-time conferencing, and multiplayer online gaming sessions all rely on rapid setup and teardown of communication links. By capitalizing on fast reconfiguration in OBS/HOBS architectures, these varied applications can minimize latency, reduce packet overhead, and make more efficient use of optical bandwidth in environments where traffic demands can shift at a moment's notice.

In traditional electronic packet switches (EPS), switching can occur on a packet-by-packet basis, often at extremely high line rates. For example, transmitting a 64-byte packet at 800 Gbps requires just 0.64 ns, implying that switching times must be far below 1 ns to avoid significant throughput penalties. Despite this requirement, many data center and HPC workloads feature elephant flows (i.e., large volumes of packets streaming between the same source and destination). In such cases, flow-based switching can replace strict packet-by-packet switching. A common industry benchmark is to keep switching overhead at or below 10% of total flow duration—meaning a flow lasting 10 μs can tolerate around 1 μs of reconfiguration time.

Furthermore, once a flow is established, subsequent packets within the same source-destination pair no longer need to include repeated header bytes (e.g., source address/destination address). By relocating header overhead to the start of the flow, the system significantly reduces per-packet overhead. As an example, in AI/ML scale-OUT environments, small flows might be 1 MB in size and large flows 40 GB. At 800 Gbps, a 1 MB transfer completes in approximately 10 μs, so an 1 μs reconfiguration time meets the 10% overhead target. In contrast, AI/ML scale-UP configurations may aggregate multiple high-speed links—such as a GPU with an 8 Tbps parallel interface (e.g., 36×224 Gb/s NVLINK channels). Here, sending 1 MB requires 1 μs of transmission time, thus reconfiguration plus acknowledgement overhead must remain under 0.1 μs to stay within 10% overhead. This ultra-fast timing also demands equivalently rapid burst-mode or switching operations.

To support these extreme rates, a GPU's 8 Tbps NVLINK interface might be segmented across five OSFP modules, each delivering 1.6 Tbps. By combining those five OSFP outputs onto a single fiber via wavelength-division multiplexing (WDM), a single port on the optical switch 14 can handle the entire 8 Tbps flow. Consequently, a 32-port OBS could interconnect 16 GPUs (each at 8 Tbps), delivering an overall 128 Tbps switching capacity. This optical approach surpasses the capabilities of electrical packet switching for such high-bandwidth flows—illustrating how optical burst switching (OBS) or hybrid OBS (HOBS) architectures deliver far greater bandwidth efficiency and scalability for AI/ML scale-up applications.

NCCL is an open-source library developed by NVIDIA to optimize and simplify communication primitives for multi-GPU and multi-node systems. It provides high-performance, low-latency collective operations (such as all-reduce, all-gather, reduce-scatter, broadcast, etc.) specifically designed for NVIDIA GPUs in both single-server (multi-GPU) and distributed cluster environments. By leveraging GPU Direct technologies and low-level networking optimizations, NCCL enables efficient scaling of deep learning, AI, and HPC applications across multiple GPUs and servers. Its key features include:
(1) Collective Communication Primitives. NCCL implements a range of collective operations—like all_reduce, reduce_scatter, all_gather, and broadcast—which are often critical in parallel training of deep neural networks and other HPC workloads.
(2) Multi-GPU and Multi-Node Support. NCCL supports both shared-memory (intra-node) and networked (inter-node) scenarios. Whether GPUs reside in a single server or across multiple interconnected servers, NCCL handles communication details and optimizations.
(3) Optimized Data Transfer Paths. Through technologies like GPUDirect RDMA, NCCL circumvents unnecessary data copies by enabling direct communication between GPUs and network interfaces, reducing overhead and latency.
(4) Hardware-Aware Topologies. NCCL automatically detects the hardware topology (such as PCIe, NVLink, InfiniBand, or Ethernet) and adaptively optimizes data transfer paths to minimize contention and bottlenecks.

Because GPUs rely on remote direct memory access (RDMA) for point-to-point (P2P) connections, both the transmitter and receiver must pre-agree on the exact number of bytes to be transferred. This requirement stems from the receiver needing to allocate local memory in advance, guaranteeing that incoming data lands in a predefined, valid address range. Accordingly, the call setup/teardown model used by these GPU connections inherently aligns with crossbar or circuit-based topologies utilizing out-of-band signaling—precisely the approach taken in OBS or HOBS systems.

In an OCS-optimized Collective Communications Library (OCCL), NVIDIA's NCCL routines would be extended to coordinate with the optical circuit switch (OCS) over an out-of-band (OOB) channel. For example, when a GPU initiates a collective operation, it could first invoke a getProperties function to confirm that the in-band optical paths align with the target devices previously discovered via the OOB connection. The system would then issue a blocking command to the OCS, awaiting a “ready” signal that confirms the new optical path is established before transmission starts. This ensures that no data is pushed until the OCS indicates a valid, switched-through channel.

The main rationale for OBS/HOBS is that they cannot accommodate grouped connections—those where multiple P2P calls overlap in time and interleave packets—without demanding sub-nanosecond reconfigurations in the optical switch. Current photonic switching technology cannot feasibly operate at such granularity. In standard NCCL, concurrent P2P operations often merge traffic from multiple flows during a collective call, which is perfectly manageable for electronic packet switches (EPS). However, flow-level switching (as opposed to packet-level switching) in OBS/HOBS calls for scheduling larger flows individually (or in small sets) to avoid excessive micro-reconfigurations. Of note, NCCL already allows developers to control which connections occur in parallel and which run sequentially, aligning nicely with an OBS/HOBS environment. By limiting concurrency to a feasible level—on the order of microseconds or milliseconds for reconfiguration—OBS/HOBS becomes a viable option for AI/ML workloads, balancing speed and efficiency.

Looking ahead, the proposed NCCL extensions, referred to here as OCCL, will optimize flow scheduling specifically for AI/ML use cases that leverage an OCS or other burst-mode optical switch. By mapping existing NCCL primitives—such as all_reduce, all_gather, reduce_scatter, and broadcast—onto an out-of-band-controlled reconfiguration workflow, OCCL harnesses the high capacity and low latency of photonic links without switching on every individual packet. This approach preserves the performance gains associated with GPU clustering while respecting OBS/HOBS constraints.

For instance, Van de Geign's algorithm is frequently employed for an all-to-all broadcast operation. In its standard form, the six steps can run in parallel, causing traffic from multiple GPU pairs to interleave—a pattern electronic packet switches handle easily. However, OBS technology would require impractically fast packet-by-packet reconfiguration. To address this, one can rewrite the algorithm so that steps occur sequentially (or in minimal groups), preserving overall efficiency yet avoiding sub-nanosecond optical switching demands. Once modified at the low-level collective library (xCCL) stage, high-level AI/ML models continue to function without major changes, ensuring minimal disruption to the existing software ecosystem.

Moreover, an optical switch is well suited for scale-out AI/ML traffic, where message sizes are large (e.g., 40 GB) and communication degree is moderate. Meanwhile, OBS/HOBS excels in scale-UP environments, where many GPUs communicate in an all-to-all pattern and smaller messages (e.g., 1 MB) require fast reconfigurations. Similar trade-offs apply in front-end data center networks. At the super-spine tier, OCS can handle large, stable flows that seldom change; moving downward to lower spine or leaf tiers, smaller and more randomized flows often benefit from OBS/HOBS, acting as an optical replacement for a packet switch. Although these are current “sweet spots,” the ongoing evolution of traffic profiles and AI/ML topologies is likely to expand the scope and applicability of OBS/HOBS in the near future.

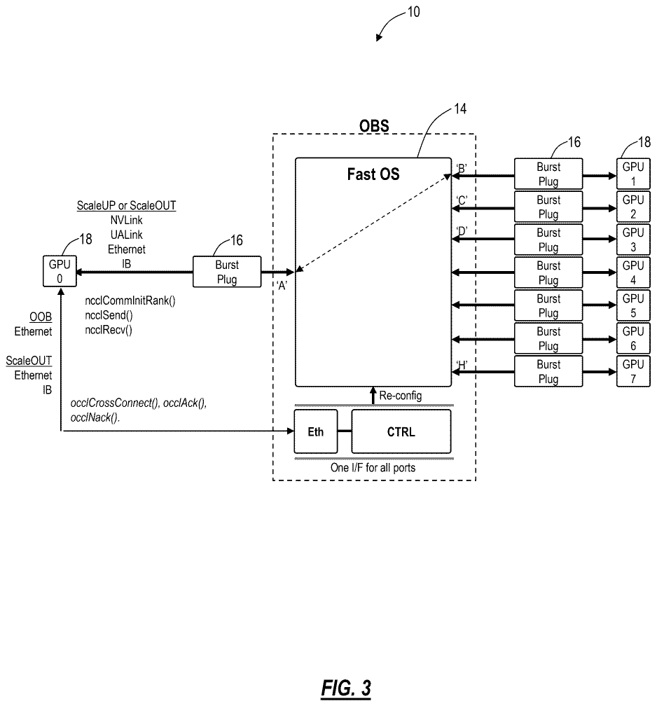

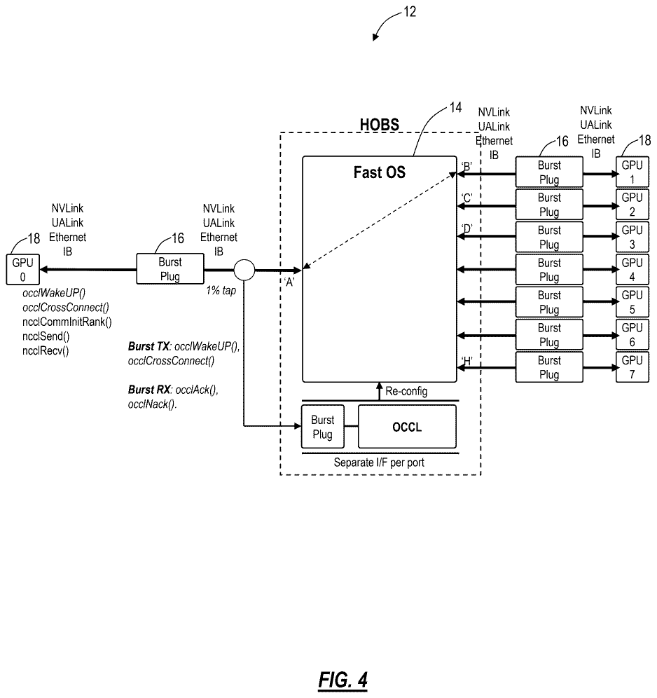

FIGS. 3 and 4 illustrate the OBS configuration 10 and the HOBS configuration 12 alongside illustrative NCCL (or OCCL) commands that manage connection setup and teardown. OBS Configuration 10 (Scale-Up Example). In scale-up environments, a 1 MB message can transmit in 1 μs at 8 Tbps, as might occur with a GPU featuring 36×NVLINK interfaces (each at 224 Gb/s). Consequently, functions such as occlCrossConnect( ) and occlAck( ) must complete in under 100 ns (i.e., ≤10% overhead) to avoid stalling the data flow. To achieve this sub-100 ns threshold, the out-of-band control path must be GPU-direct, bypassing any slower CPU-driven software stack. This high-speed coordination ensures that when a burst starts, the optical switch is already configured, and acknowledgments arrive with minimal latency.

HOBS Configuration 12 (Scale-Out Example). Conversely, in HOBS systems, NCCL can operate in-band with various underlying protocols—such as NVLink, UALink, Ethernet, or InfiniBand—exchanging connection details seamlessly without requiring an external control channel for each packet. In this arrangement, the OCS employs a burst Optical-to-Electrical (O/E) receiver to “snoop” on NCCL's connection setup messages. To cut costs, the burst plug 16 may filter relevant control frames and forward them via a second wavelength, letting the main data wavelength run uninterrupted. Consider a 1 MB message at 800 Gbps, which requires roughly 10 μs to transmit. Accordingly, procedures like occlWakeUP( ) and occlCrossConnect( ) must finish within 1 μs to stay under the 10% overhead threshold. By embedding the control signals in-band—yet isolating them on a separate wavelength once identified—HOBS can achieve fast reconfiguration with only minimal additional hardware, optimizing both performance and cost in AI/ML scale-out networks.

### Fast Optical Switching System

In an embodiment, a system for fast optical switching includes an optical switch 14 having N ports, wherein the optical switch 14 is configured to reconfigure optical paths among the N ports in a microsecond or sub-microsecond timescale; a plurality of burst-mode optical transceivers 16 coupled to respective ones of the N ports, each burst-mode optical transceiver 16 configured to establish optical communication with another burst-mode optical transceiver 16 via the optical switch 14, and to acquire an optical signal in a microsecond or sub-microsecond timescale upon reconfiguration of the optical switch 14; and a control system configured to coordinate switching events in the optical switch 14 with acquisition events in the burst-mode optical transceivers 16.

The control system and the burst-mode optical transceivers 16 operate together to enable short-lived, high-bandwidth connections suitable for optical burst switching (OBS) or hybrid optical burst switching (HOBS). The optical switch 14 can be implemented via silicon photonics (SiP) technology, including one or more of Mach-Zehnder interferometers, ring resonators, or free-carrier injection elements, each reconfigurable to achieve the microsecond or sub-microsecond timescale.

At least one burst-mode optical transceiver can be a coherent light transceiver optimized for short-reach data center or campus environments, configured to reduce digital signal processing (DSP) complexity and perform partial or incremental training to achieve faster acquisition. At least one burst-mode optical transceiver can be an intensity-modulation direct-detect (IMDD) transceiver configured with burst-mode PAM4 operation, and wherein the control system pre-coordinates optical path changes to allow the PAM4 transceivers to re-lock within microseconds. At least one burst-mode optical transceiver can include an always-on host SerDes interface and a burst-mode line side, such that the host SerDes remains continuously active while only the line side retrains upon each new optical path established through the optical switch.

The control system can be realized over an out-of-band (OOB) interface, the control system sending reconfiguration commands to the optical switch ahead of a flow change, enabling each burst-mode optical transceiver to anticipate and minimize reacquisition time. The control system can be realized through an in-band control plane, each burst-mode optical transceiver including a small optical tap or in-band header-detection logic for identifying burst or flow setup data and signaling the optical switch to reconfigure accordingly.

At least one burst-mode optical transceiver can further include a buffer configured to aggregate multiple packet headers into a single flow-level header at the start of a burst, thereby reducing redundant header overhead and minimizing repeated acquisition steps during a burst. At least one burst-mode optical transceiver can be configured to run an asymmetric line rate, buffering host-side traffic at a first rate and transmitting to the optical switch at a higher rate in order to mask reconfiguration or DSP lock times. At least one burst-mode optical transceiver can include dual-wavelength capability, employing a primary data wavelength and a secondary control wavelength, the secondary control wavelength conveying switch reconfiguration commands without interrupting data flow.

The system can further include a wake-up signaling mechanism wherein a host device or graphics processing unit (GPU) transmits an out-of-band wake-up code via one of the burst-mode optical transceivers to a remote transceiver, causing the remote transceiver to pre-initialize clock and carrier recovery before data arrives. The control system can support multi-stage path setup, allowing an end-to-end connection to be formed from multiple intermediate segments in parallel or in series, reducing overall reconfiguration latency through overlapping or incremental acquisition. At least one burst-mode optical transceiver can be integrated as co-packaged optical (CPO) or on-board optical (OBO), placing its optical and DSP components in close proximity to a host application-specific integrated circuit (ASIC) for shorter electrical interfaces and faster acquisition.

### Process

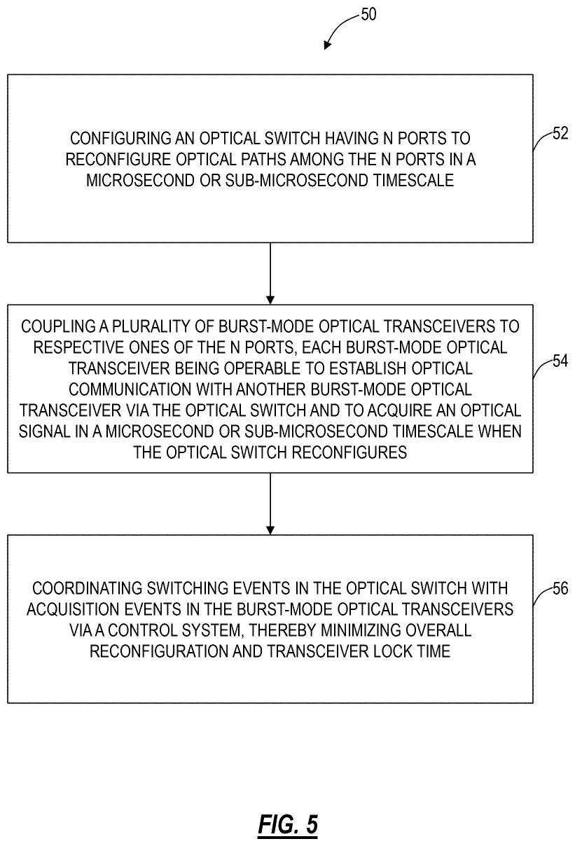

FIG. 5 illustrates a flowchart of a process 50 for fast optical switching based on the approaches described herein. The process 50 includes configuring an optical switch having N ports to reconfigure optical paths among the N ports in a microsecond or sub-microsecond timescale (step 52); coupling a plurality of burst-mode optical transceivers to respective ones of the N ports, each burst-mode optical transceiver being operable to establish optical communication with another burst-mode optical transceiver via the optical switch and to acquire an optical signal in a microsecond or sub-microsecond timescale when the optical switch reconfigures (step 54); and coordinating switching events in the optical switch with acquisition events in the burst-mode optical transceivers via a control system, thereby minimizing overall reconfiguration and transceiver lock time (step 56).

The process 50 can further include operating the control system and the burst-mode optical transceivers together to enable short-lived, high-bandwidth connections suitable for optical burst switching (OBS) or hybrid optical burst switching (HOBS). The process 50 can further include implementing the optical switch in silicon photonics (SiP) technology using phase-shifting elements or ring resonators, and executing reconfiguration instructions to achieve the microsecond or sub-microsecond timescale. The process 50 can further include retaining certain digital signal processing (DSP) parameters in each burst-mode optical transceiver so that, upon a new connection setup, the transceiver only performs partial re-lock procedures, thereby reducing acquisition from seconds to microseconds.

The process 50 can further include maintaining a host-side serializer-deserializer (SerDes) interface continuously active while activating a burst-mode line side only after receiving notification of an impending optical path change; and instructing the burst-mode optical transceivers to switch to a new optical path in coordination with the control system so that any overhead for re-locking remains below ten percent of each data flow's duration. The process 50 can further include employing a second wavelength in each optical link for control signals, enabling the optical switch to be reconfigured without interrupting main data flow on a primary wavelength.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; central processing units (CPUs); digital signal processors (DSPs); specialized processors such as network processors (NPs) or network processing units (NPUs), graphical processing units (GPUs); field programmable gate arrays (FPGAs); programmable logic device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more application-specific integrated circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, read-only memory (ROM), programmable read-only memory (PROM), erasable programmable read-only memory (EPROM), electrically erasable programmable read-only memory (EEPROM), flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

In this disclosure, including the claims, the phrases “at least one of” or “one or more of,” when referring to a list of items, encompass any combination of those items, including any single item. For example, the expressions “at least one of A, B, or C,” “at least one of A, B, and C,” “one or more of A, B, or C,” and “one or more of A, B, and C” cover the possibilities of only A, only B, only C, any combination of A and B, A and C, B and C, or all three (A, B, and C). This also includes scenarios involving more or fewer elements than A, B, and C. Additionally, the terms “comprise,” “comprises,” “comprising,” “include,” “includes,” and “including” are intended to be open-ended and non-limiting, specifying essential elements or steps without excluding additional elements or steps—even where a claim or multiple claims contain more than one such term.

It should be understood that the drawings, descriptions, and examples provided herein merely illustrate various aspects and embodiments of the disclosure. Numerous modifications, changes, or arrangements may be made without departing from the spirit and scope of the disclosure. Although certain steps, operations, instructions, blocks, or similar elements (collectively referred to as “steps”) are depicted or described in a specific order, such ordering is not necessarily required unless explicitly stated. Nor does it imply that all depicted steps are essential to achieve the desired results. Extra steps may be performed before, after, concurrently, or interspersed with the illustrated or described steps. Multitasking, parallel processing, and other types of concurrent execution are also contemplated. Further, the separation of system components or steps described should not be interpreted as mandatory in all implementations; such components, steps, or elements may be integrated into a single configuration or distributed across multiple ones.

While this disclosure has been shown and described through specific embodiments and examples, those skilled in the art will recognize that many variations and modifications can provide equivalent functionality or yield comparable results. Such alternative embodiments and variations, even if not explicitly mentioned here, fall within the spirit and scope of this disclosure if they achieve the stated objectives and adhere to the underlying principles. Accordingly, they are envisioned and encompassed by the disclosure and protected by the associated claims. In other words, the present disclosure anticipates combinations and permutations of the described elements, operations, steps, methods, processes, algorithms, functions, techniques, modules, and circuits in any feasible sequence or arrangement—whether collectively, separately, or in subsets—thereby broadening the range of potential embodiments.

What is claimed is:

1. A system for fast optical switching, comprising:
an optical switch having N ports, wherein the optical switch is configured to reconfigure optical paths among the N ports in a microsecond or sub-microsecond timescale;
a plurality of burst-mode optical transceivers coupled to respective ones of the N ports, each burst-mode optical transceiver configured to establish optical communication with another burst-mode optical transceiver via the optical switch, and to acquire an optical signal in a microsecond or sub-microsecond timescale upon reconfiguration of the optical switch; and
a control system configured to coordinate switching events in the optical switch with acquisition events in the burst-mode optical transceivers.

2. The system of claim 1, wherein the control system and the burst-mode optical transceivers operate together to enable short-lived, high-bandwidth connections suitable for optical burst switching (OBS) or hybrid optical burst switching (HOBS).

3. The system of claim 1, wherein the optical switch is implemented via silicon photonics (SiP) technology, including one or more of Mach-Zehnder interferometers, ring resonators, or free-carrier injection elements, each reconfigurable to achieve the microsecond or sub-microsecond timescale.

4. The system of claim 1, wherein at least one burst-mode optical transceiver is a coherent light transceiver optimized for short-reach data center or campus environments, configured to reduce digital signal processing (DSP) complexity and perform partial or incremental training to achieve faster acquisition.

5. The system of claim 1, wherein at least one burst-mode optical transceiver is an intensity-modulation direct-detect (IMDD) transceiver, and wherein the control system pre-coordinates optical path changes to allow the IMDD transceivers to re-lock within microseconds.

6. The system of claim 1, wherein at least one burst-mode optical transceiver includes an always-on host SerDes interface and a burst-mode line side, such that the host SerDes remains continuously active while only the line side retrains upon each new optical path established through the optical switch.

7. The system of claim 1, wherein the control system is realized over an out-of-band (OOB) interface, the control system sending reconfiguration commands to the optical switch ahead of a flow change, enabling each burst-mode optical transceiver to anticipate and minimize reacquisition time.

8. The system of claim 1, wherein the control system is realized through an in-band control plane, each burst-mode optical transceiver including a small optical tap or in-band header-detection logic for identifying burst or flow setup data and signaling the optical switch to reconfigure accordingly.

9. The system of claim 1, wherein at least one burst-mode optical transceiver further includes a buffer configured to aggregate multiple packet headers into a single flow-level header at a start of a burst, thereby reducing redundant header overhead and minimizing repeated acquisition steps during a burst.

10. The system of claim 1, wherein at least one burst-mode optical transceiver is configured to run an asymmetric line rate, buffering host-side traffic at a first rate and transmitting to the optical switch at a higher rate in order to mask reconfiguration or DSP lock times.

11. The system of claim 1, wherein at least one burst-mode optical transceiver includes dual-wavelength capability, employing a primary data wavelength and a secondary control wavelength, the secondary control wavelength configured to convey switch reconfiguration commands without interrupting data flow.

12. The system of claim 1, further comprising a wake-up signaling mechanism wherein a host device or graphics processing unit (GPU) transmits an out-of-band wake-up code via one of the burst-mode optical transceivers to a remote transceiver, causing the remote transceiver to pre-initialize clock and carrier recovery before data arrives.

13. The system of claim 1, wherein the control system supports multi-stage path setup, allowing an end-to-end connection to be formed from multiple intermediate segments in parallel or in series, reducing overall reconfiguration latency through overlapping or incremental acquisition.

14. The system of claim 1, wherein at least one burst-mode optical transceiver is integrated as co-packaged optical (CPO) or on-board optical (OBO), placing its optical and DSP components in close proximity to a host application-specific integrated circuit (ASIC) for shorter electrical interfaces and faster acquisition.

15. A method for fast optical switching comprising steps of:
configuring an optical switch having N ports to reconfigure optical paths among the N ports in a microsecond or sub-microsecond timescale;
coupling a plurality of burst-mode optical transceivers to respective ones of the N ports, each burst-mode optical transceiver being operable to establish optical communication with another burst-mode optical transceiver via the optical switch and to acquire an optical signal in a microsecond or sub-microsecond timescale when the optical switch reconfigures; and
coordinating switching events in the optical switch with acquisition events in the burst-mode optical transceivers via a control system, thereby minimizing overall reconfiguration and transceiver lock time.

16. The method of claim 15, wherein the steps further include
operating the control system and the burst-mode optical transceivers together to enable short-lived, high-bandwidth connections suitable for optical burst switching (OBS) or hybrid optical burst switching (HOBS).

17. The method of claim 15, wherein the steps further include
implementing the optical switch in silicon photonics (SiP) technology using phase-shifting elements or ring resonators, and executing reconfiguration instructions to achieve the microsecond or sub-microsecond timescale.

18. The method of claim 15, wherein the steps further include
retaining certain digital signal processing (DSP) parameters in each burst-mode optical transceiver so that, upon a new connection setup, the transceiver only performs partial re-lock procedures, thereby reducing acquisition from seconds to microseconds.

19. The method of claim 15, wherein the steps further include
maintaining a host-side serializer-deserializer (SerDes) interface continuously active while activating a burst-mode line side only after receiving notification of an impending optical path change; and
instructing the burst-mode optical transceivers to switch to a new optical path in coordination with the control system so that any overhead for re-locking remains below ten percent of each data flow's duration.

20. The method of claim 15, wherein the steps further include
employing a second wavelength in each optical link for control signals, enabling the optical switch to be reconfigured without interrupting main data flow on a primary wavelength.
